(19) United States
(12) Patent Application Publication
(10) Pub. No.: US 2008/0179077 A1
(43) Pub. Date: Jul. 31, 2008

(54) High-voltage bushing

(75) Inventors: Andrej Krivda, Wettingen (CH); Vincent Tilliette, Zurich (CH); Jens Rocks, Freienbach (CH); Henrik Hillborg, Vasteras (SE); Olof Hjortstam, Vasteras (SE); Leopold Ritzer, Untersiggenthal (CH); Patrick Meier, Staufen (CH)

Correspondence Address: BUCHANAN, INGERSOLL & ROONEY PC, POST OFFICE BOX 1404, ALEXANDRIA, VA, 22313-1404, US

(73) Assignee: ABB Research Ltd, Zurich (CH)

(21) Appl. No.: 11/987,974

(22) Filed: Dec. 6, 2007

Related U.S. Application Data
(63) Continuation of application No. PCT/CH2006/000298, filed on Jun. 6, 2006.

(30) Foreign Application Priority Data
Jun. 7, 2005 (EP) 05405370.7

(51) Int. Cl. H01B 17/26; H01B 19/00

(52) U.S. Cl. 174/152 R; 29/887

(57) ABSTRACT

The bushing has a conductor and a core surrounding the conductor. The core comprises a sheet-like spacer, wherein the spacer contains filler particles. The bushing can be a resin-impregnated graded bushing impregnated with an electrically insulating matrix material. The spacer may comprise paper, in particular creped paper. The filler particles can be electrically insulating or semiconductive particles. An increased thermal conductivity of the core can be achieved.

### RELATED APPLICATIONS

This application claims priority under 35 U.S.C. §119 to EP Application 05405370.7 filed in Europe on Jun. 7, 2005, and as a continuation application under 35 U.S.C. §120 to PCT/CH2006/000298 filed as an International Application on Jun. 6, 2006, designating the U.S., the entire contents of which are hereby incorporated by reference in their entireties.

### TECHNICAL FIELD

The disclosure relates to the field of high-voltage technology. It relates to a bushing, a high- or medium-voltage apparatus, a transformer and a method of production of a bushing and the use of a sheet-like material according to the opening clause of the claims. Such bushings find application, e.g., in transformers, gas-insulated switchgears, generators or as test bushings.

### BACKGROUND INFORMATION

Bushings are devices that are usually used to carry current at high potential through a grounded barrier, e.g., a transformer tank. In order to decrease and control the electric field near and inside the bushing, condenser bushings have been developed, also known as (fine-) graded bushings. Condenser bushings facilitate electrical stress control through insertion of floating equalizer (electrode) plates, which are incorporated in the core of the bushing. The condenser core decreases the field gradient and distributes the field along the length of the insulator, which provides for low partial discharge readings well above nominal voltage readings.

The condenser core of a bushing is typically wound from kraft paper or creped kraft paper as a spacer. Equalization plates, which are used in graded bushings, are constructed of either metallic (typically aluminium) inserts or conductive or semiconductive patches (ink, graphite paste). The equalization plates are located coaxially, so as to achieve an optimal balance between external flashover and internal breakdown strength. The paper spacer ensures a defined position of the electrode plates and provides for mechanical stability.

The condenser cores of today's bushings are impregnated either with oil (OIP, oil-impregnated paper) or with resin (RIP, resin-impregnated paper). RIP bushings are dry (oil free) bushings. The core of an RIP bushing is wound from paper, with the electrode plates being inserted in appropriate places between neighboring paper windings. The resin is then introduced during a heating and vacuum process of the core.

In the GB 999 609 A a method of manufacturing a bushing insulator is disclosed. During the manufacturing process the paper or web is one side coated with resin, winded onto a conductor or mandrel into the form of a bushing and sheets of metal foil are inserted periodically between the adjacent turns. The epoxy-resin can incorporate fillers in powdered form with a particle size of 5 to 100 microns. Due to the high molecular weight of the resin a penetration into the paper web is prevented.

A casting procedure for manufacturing electrical bushings is disclosed in U.S. Pat. No. 3,394,455. In a first step a body member of resinous insulating material containing inorganic fillers as silica is caste about an inner conductor. Overlapping tubular conductive or semi conductive plates which are formed of metal sheets or silicon carbide sheets or carbon impregnated sheets, used to distribute the electrical stress are then placed onto the body member with air space between each. The air space is then filled with the insulating resin containing fillers.

In U.S. Pat. No. 4,038,491 an electrical bushing assembly is described whose conductor stud is fully encapsulated by a cured epoxy resin-filler composition. The composition of about 85 weight percent of powdered glassy fillers with a high thermal conductivity fills the space between the inner conductor stud and the surrounding flange portion. Further bushings according prior art are mentioned in US 2003/014861A1, WO 99/33065A, DE 12 43745B, and U.S. Pat. No. 3,271,509.

It would be desirable to improve mechanical and/or electrical and/or thermal properties and/or the manufacturability of bushings, in particular of impregnated bushings.

### SUMMARY

Therefore, the goal of the disclosure is to create a bushing with improved mechanical and/or electrical and/or thermal properties and/or manufacturability.

A bushing with a conductor and a core surrounding the conductor is disclosed, the core comprising equalization electrodes and a sheet-like spacer. The spacer contains filler particles which are pre-filled into the spacer before an impregnation process and which increase the thermal conductivity with respect to the spacer without any pre-filled particles.

A method of production of a bushing is disclosed, wherein a sheet-like spacer is wound around a conductor or around a mandrel, comprising the step of adding equalization electrodes during winding, characterized by the steps of: Prefilling the sheet-like spacer with filler particles before an impregnation process, wherein the filler particles increase the thermal conductivity with respect to the spacer without any pre-filled particles.

### BRIEF DESCRIPTION OF THE DRAWINGS

Below, the invention is illustrated in more detail by means of exemplary embodiments, which are shown in the included drawings. The figures show schematically:

FIG. 1 a cross-section (in axial plane) of a fine-graded bushing, partial view;

FIG. 1A an enlarged detail of FIG. 1;

FIG. 2 a cross-section (in radial plane) of the inner part of a fine-graded bushing:

FIG. 3 a HV-or MV apparatus (transformer).

The reference symbols used in the figures and their meaning are summarized in the list of reference symbols. Generally, alike or alike-functioning parts are given the same reference symbols. The described embodiments are meant as examples and shall not confine the invention.

### DETAILED DESCRIPTION

According to the disclosure, a bushing has a conductor and a core surrounding the conductor. The core comprises a sheet-like spacer. The bushing is characterized in that the spacer contains filler particles which are pre-filled into the spacer before an impregnation process and which increase the thermal conductivity with respect to the spacer without any pre-filled particles.

Through this, it is possible to taylor various properties of the bushing. For example, a higher mechanical rigidity of the bushing can be achieved. This is the case, e.g. in the case of a resin-impregnated bushing, if the use of the filler particles leads to a reduced amount of resin within the core, and with the filler particles showing a smaller elasticity than the resin, which is used for an impregnation.

It is also possible to achieve better thermal properties, which allows to use a bushing of similar dimensions at higher current ratings, or to use a smaller bushing at similar ratings. This is the case, if the thermal conductivity of the bushing with filler particles is higher than the thermal conductivity of the bushing without filler particles. This can, in the case of a resin-impregnated bushing, also lead to an improved manufacturability, because the curing of the resin may take place at higher temperatures, so that the curing process takes less time. Accordingly, it is possible to accelerate the production of high- or medium-voltage bushings.

It is also possible to achieve an improved tan δ and/or an improved permittivity of the core, if appropriate filler particles are used.

Furthermore, it is possible that the water-uptake of the bushing is decreased through the use of the filler particles, and an increased fracture toughness (higher crack resistance) can be achieved (higher crack resistance).

Also the thermomechanical stability and lifetime of the bushings can be beneficially influenced, in that the mismatch of the coefficient of thermal expansion (CTE) between core and conductor (or mandrel) is decreased through the use of the filler particles. A lower CTE of the core due to the use of a filler-particles containing spacer and/or a matrix material with a filler will lead to a reduced total chemical shrinkage during curing. This enables the production of (near) end-shape bushings (machining free), and therefore considerably reduces the production time.

Of course, the filler particles in the spacer are not meant to be (only) those filler particles, which are contained within a matrix material for impregnation and which might be incorporated within the spacer through impregnation of the core with the filler-particle containing matrix. Accordingly, the spacer as disclosed can be called a “spacer pre-filled with filler particles”. The “pre-filled” refers then to the fact that the spacer contains the filler particles already before other filler particles are possibly incorporated into the spacer, e.g., through an impregnation process. The spacer can be filled with the filler particles even before it is arranged (wound) around the core. The filler particles in an impregnation matrix may be of a different kind as those within the spacer, or of partially or fully the same type.

It is also possible to use an unfilled resin or a resin with small filler content and yet achieve the same beneficial properties of filler particles in the core as would otherwise be achieved only with (more) filler in the impregnation matrix (and an unfilled spacer). With respect to using an unfilled spacer and a filler-containing matrix, an improved (accelerated) manufacturing process is enabled, and/or a larger particle size of the filler particles to be finally in the core can be used.

The conductor typically is a rod or a tube or a wire. The core provides for electrical insulation of the conductor and may (but does not have to) contain equalization plates. Typically, the core is substantially rotationally symmetric and concentric with the conductor. The flat spacer can be impregnated with a polymer (resin) or with oil or with some other electrically insulating matrix material. The flat spacer can be paper (craft paper, creped paper) or a different material (e.g., a polymer or some textured flat material), which is typically wound, in spiral form, around the conductor, thus forming a multitude of neighboring layers.

In an exemplary embodiment, a multitude of layers surrounding the conductor is formed by the spacer. Typically, the spacer is wound around the conductor or a mandrel forming a spiral. This enhances the manufacturability though use of only one piece of spacer material (or a small number of pieces of spacer material). Accurate positioning of electrodes is enabled.

In another exemplary embodiment, the filler-particle-containing spacer is impregnated with an electrically insulating matrix material. The matrix material can, e.g., be oil or a resin (filled or unfilled).

In yet another exemplary embodiment, the spacer is wound around an axis, which axis is defined through the shape of the conductor. In appropriate radial distances to the axis equalization plates of metallic or semiconducting material are provided within the core.

Such a bushing is a graded or a fine-graded bushing. Typically, one single layer of the spacer material is wound around the conductor or around a mandrel so as to form a spiral of spacer material. In particular in the case of very long bushings, two or more axially shifted strips of spacer material may be wound in parallel. It is also possible to wind a spiral of double-layer or even thicker spacer material; such a double- or triple-layer could then nevertheless be considered as the one layer of spacer material, which spacer material in that case would happen to be double- or triple-layered.

The equalization plates can be pieces of metallic foil, e.g., of aluminium, which are inserted into the core after certain numbers of windings, so that the equalization plates are arranged and fixed in a well-defined, prescribable radial distance to the axis. The metallic or semiconducting material for the equalization plates can also be provided for through application of such material to the spacer, e.g., through spraying, printing, coating, plasma spraying or chemical vapor deposition or the like.

The spacer can comprise fibers, e.g., cellulose fibers. A fibrous spacer can be well penetrated by an insulating matrix, through the capillary effect. The spacer can be, in addition to the filler particles, substantially made of fibers, e.g., of cellulose fibers. Paper, and in particular creped paper, is an example for such a spacer.

The spacer can, e.g., also comprise or substantially be a polymer (in addition to the filler particles). With respect to using cellulose for the spacer, this can reduce the bushing's manufacturing time, because the drying time can be strongly reduced. It is also possible to have glass fibers in the spacer, either instead of other fibers or in addition to other fibers, e.g., in addition to cellulose fibers and/or polymer fibers.

The filler particles can be electrically insulating or semiconductive. For example, filler particles can be substantially made of or contain at least one of the following substances: SiO₂, Al₂O₃, BN, AlN, BeO, SiC, Si₃N₄, B₄C, ZnO, BaTiO₃, BaSO₄, TiB₂TiO₂ (titanium dioxide), calcium carbonate, hydrated alumina, diamond, clay, mica. It is possible to use particles of doped material and of a mixture of various materials. It is also possible to have a mixture of various kinds of filler particles in the spacer. For achieving an improved adhesion between the filler particles and a matrix material and/or the spacer material, the filler particles may be surface-treated, e.g., by coating, e.g., with epoxy silane.

The filler particles can be inorganic particles. But also organic fillers might be used. The physical state of the particles can be solid.

The filler particles can have a low permittivity, e.g., a permittivity smaller than 100, preferably smaller than 10, preferably smaller than 5.

The filler particles can have a tan δ below 1, below 10⁻¹, better below 10⁻², even better below 4·10⁻³, or even below 1·10⁻³.

The filler particles can make up at least 1% by weight, e.g., at least 3% or at least 5% or at least 10% by weight, of the spacer. The filler particles content may be up to 50%, 70% or more by weight. The exact filler particle content can be chosen according to the needs (which properties to be reached) and to the manufacturability of the spacer and of the bushing incorporating the spacer with the filled paper.

It is possible to use nanometer-sized particles as well as micrometer-sized particles as filler particles in the spacer.

In an exemplary embodiment of the disclosure, the spacer containing the filler particles has an increased thermal conductivity with respect to the spacer without any filler particles. This can be achieved with filler particles having a higher thermal conductivity than the unfilled spacer. The advantages have been sketched above: better thermal properties of the bushing, allowing a bushing of smaller dimensions to carry high currents (compact design of bushing and/or higher current ratings) and better (faster) manufacturability of the bushing if the bushing has to be cured (e.g., in case of resin-impregnation).

A higher thermal conductivity of the core through use of filler particles in the spacer and/or a matrix material with a filler will allow for an increased current rating of the bushing or for a reduced size and possibly a reduced weight of the bushing at the same current rating. Also the heat distribution within the bushing under operating conditions is more uniform when filler particles of high thermal conductivity are used.

The thermal conductivity can be even further increased by improving the interface (adhesion) between the particles and the matrix, e.g., through a surface treatment, and/or by achieving percolation of the filler particles in the spacer.

The spacer has a thermal conductivity of at least 0.2 W·m⁻¹·K⁻¹, in particular of at least 0.8 W·m⁻¹·K⁻¹. Bushings known from the art, with resin-impregnated paper (without filler) usually show a thermal conductivity of about 0.1 W·m⁻¹·K⁻¹, to 0.2 W·m⁻¹·K⁻¹. As an example, a thermal conductivity of above 2 W·m⁻¹·K⁻¹, above 5 W·m⁻¹·K⁻¹ or above 10 W·m⁻¹·K⁻¹, or even above 20 W·m⁻¹·K⁻¹ can be reached. The type and amount of filler particles can be chosen accordingly. For example, SiO₂ has a thermal conductivity of 1.4 W·m⁻¹·K⁻¹, Al₂O₃ has a thermal conductivity of 30 W·m⁻¹·K⁻¹, AlN has a thermal conductivity of 260 W·m⁻¹·K⁻¹, and BN has a thermal conductivity of 300 W·m⁻¹·K⁻¹.

In another embodiment, the spacer is coated and/or surface treated for an improved adhesion between the spacer and a matrix material, with which it is to be impregnated. Depending on the spacer material, it is possible to brush, etch, coat or otherwise treat the surface of the spacer, so as to achieve an improved interaction between the spacer and the matrix material. This will provide for an enhanced thermomechanical stability of the core.

In another embodiment, the spacer is wound around an axis (A), which axis (A) is defined through the shape of the conductor, and the kind of filler particles and/or the size of the filler particles and/or the concentration of the filler particles in the spacer varies along the direction parallel to the axis (A) and/or along the direction perpendicular to that direction.

In another embodiment, when the bushing is an impregnated bushing comprising an electrically insulating matrix material, the matrix material also comprises filler particles (of fully or partially the same, or of different kind and/or concentration). An exemplary matrix material comprises a polymer and filler particles. The polymer can for example be an epoxy resin, a polyester resin, a polyurethane resin, or another electrically insulating polymer. The filler particles in the matrix can be electrically insulating or semiconducting. The filler particles in the matrix can, e.g., be particles of SiO₂, Al₂O₃, BN, AlN, BeO, TiB₂, TiO₂, SiC, Si₃N₄, B₄C, diamond, clay, mica or the like, or mixtures thereof. It is also possible to have a mixture of various such particles in the polymer. The physical state of the particles can be solid. Compared to a core with un-filled expoxy as matrix material, there will be less epoxy in the core, if a matrix material with a filler is used. Accordingly, the time needed to cure the epoxy can be considerably reduced, which reduces the time needed to manufacture the bushing.

An exemplary high- or medium-voltage apparatus comprises a bushing as disclosed. Such an apparatus can, e.g., be a switchgear or a also a high- or medium-voltage installation (e.g., a power plant). An exemplary transformer comprises at least one bushing as disclosed.

As disclosed, a method of production of a bushing comprises the steps of winding a sheet-like spacer around a conductor or around a mandrel and using as the spacer a sheet-like material containing filler particles. The (or some) filler particles can be contained in the spacer already before a possible impregnation of the spacer takes place. It is possible that the sheet-like spacer is provided with filler particles when it is already wound around the conductor or around the mandrel; after that, the filler-containing spacer is then impregnated with an electrically insulating matrix material.

The filler particles can be incorporated into the spacer before the spacer is wound around the conductor or around the mandrel. For example, the filler is incorporated in the spacer already during the production of the spacer. If, e.g., a paper is used as spacer, the filler particles can be added to the cellulose pulp, which is then formed in a sheet-like form and dried. Mineral fillers like, e.g., calcium carbonate, hydrated alumina, titanium dioxide, have been used in the paper industry for many years to make the paper smoother and brighter, to decrease its costs or to suppress the growth of fungi. For example, hydrated alumina is used in manufacturing of higher quality printing papers to enhance whiteness, opacity, and printability. For incorporating filler particles in a paper for use in a bushing as disclosed, methods known from the paper industry can be used.

The disclosure can also comprise the use of a sheet-like material, which contains filler particles, as a spacer in a core of a bushing.

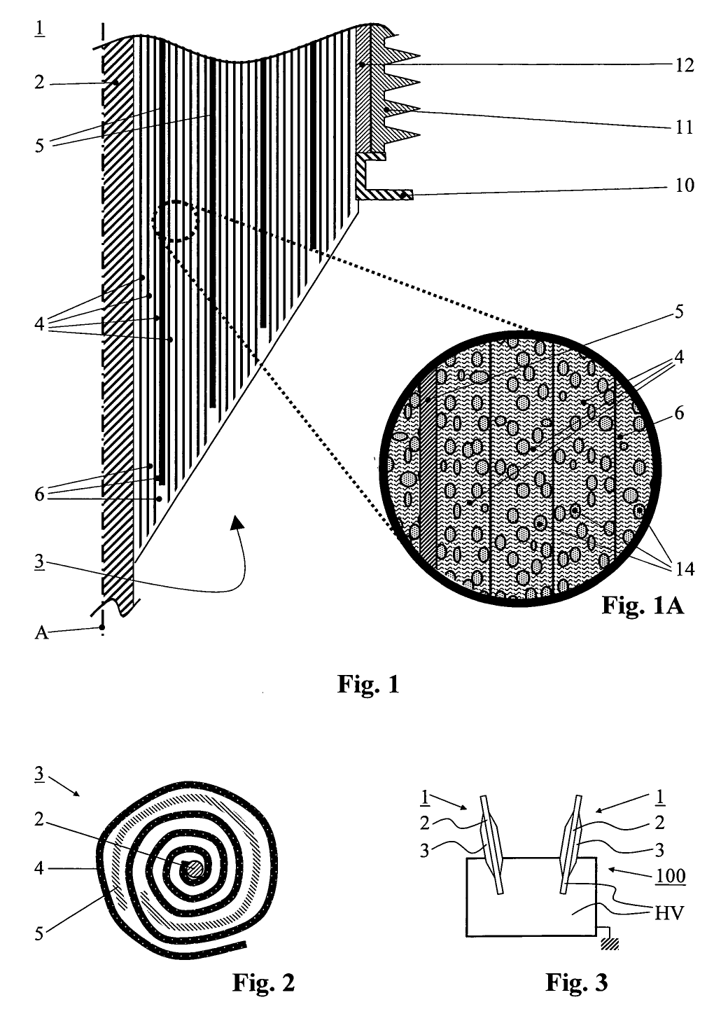

FIG. 1 schematically shows a partial view of a cross-section of a fine-graded bushing 1. The bushing is substantially rotationally symmetric with a symmetry axis A. In the center of the bushing 1 is a solid metallic conductor 2, which also could be a tube or a wire. The conductor 2 is partially surrounded by a core 3, which also is substantially rotationally symmetric with the symmetry axis A. The core 3 comprises a spacer 4, which is wound around a core and impregnated with a curable epoxy 6 as a matrix material 6. In prescribable distances from the axis A pieces of aluminium foil 5 are inserted between neighboring windings of the spacer 4, so as to function as equalizing plates 5. On the outside of the core, a flange 10 is provided, which allows to fix the bushing to a grounded housing of a transformer or a switchgear or the like. Under operation conditions the conductor 1 will be on high potential, and the core provides for the electrical insulation between the conductor 2 and the flange 10 on ground potential. On that side of the bushing 2, which usually is located outside of the housing, an insulating envelope 11 surrounds the core 3. The envelope 11 can be a hollow composite made of, e.g., porcellain, silicone or an epoxy. The envelope may be provided with sheds or, as shown in FIG. 1, provide sheds. The envelope 11 shall protect the core 3 from ageing (UV radiation, weather) and maintain good electrical insulating properties during the entire life of the bushing 1. The shape of the sheds is designed such, that it has a substantially self-cleaning surface when it is exposed to rain. This avoids dust or pollution accumulation on the surface of the sheds, which could affect the insulating properties and lead to electrical flashover.

In case that there is an intermediate space between the core 3 and the envelope 11, an insulating medium 12, e.g., an insulating liquid 12 like silicone gel or polyurethane gel, can be provided to fill that intermediate space.

The enlarged partial view FIG. 1A of FIG. 1 shows the structure of the core 3 in greater detail. The spacer 4 is sheet-like, in this case made of paper, and forms several neighboring layers 4. One equalizing plate 5 is also shown. Equalizing plates 5 are inserted in certain distances from the axis A between neighboring spacer windings. Through the number (integer or non-integer) of spacer windings between neighboring equalizing plates 5 the (radial) distance between neighboring equalizing plates 5 can be chosen. The radial distance between neighboring equalizing plates 5 may be varied from equalizing plate to equalizing plate.

The paper layers in FIG. 1A are shown as touching each other practically on their full surface. Usually, creped paper can be used. The corrugated surface of creped paper (with its many creases and folds) will lead to the formation of channels between neighboring paper layers. These channels will be filled with matrix material 6 upon impregnation and strongly help the matrix material 6 to penetrate the space between neighboring layers. Due to the fibrous structure of paper 4 the matrix material 6 will also penetrate the paper 4 itself.

The matrix material 6 of the core 3 can be a particle-filled polymer. For example an epoxy resin or a polyurethane filled with particles of Al₂O₃. Typical filler particle sizes are of the order of 10 nm to 300 μm. The spacer is shaped such that the filler particles can distribute throughout the core 3 during impregnation.

In FIG. 1A the filler particles 14 contained in the paper 4 are shown. They can, e.g., be Al₂O₃ particles of sizes in the range 1 pm to 40 μm.

FIG. 2 schematically illustrates a cross-section (in a radial plane) of the inner part of a fine-graded bushing, like a bushing shown in FIGS. 1 and 1A. In the middle is the conductor 2. The sheet-like spacer 4 is wound to a spiral around the conductor 2 and filled with filler particles as indicated by the white dots in the spacer 4. For reasons of clarity of FIG. 2, neighboring layers are drawn to be rather distant from each other, which usually is not the case. Usually, the core is wound with some force, so that neighboring layers touch each other.

An equalizing plate 5 is indicated as a dashed line. The equalizing plates 5 can approximately fully surround the conductor, as indicated in FIG. 2.

The thermal conductivity of a standard resin-impregnated core with paper as spacer 4 and without filler particles (in resin 6 or paper 4) is typically about 0.15 W/mK to 0.2 W/mK. As disclosed, values of at least 0.3 W·m⁻¹·K⁻¹ to 0.9 W·m⁻¹·K⁻¹ or even above and far above 1.2 W·m⁻¹·K⁻¹ or 2 W·m^{-1 ·K}⁻¹ for the thermal conductivity of the bushing core 3 can readily be achieved.

In addition, the coefficient of thermal expansion (CTE) of the core 3 can be much smaller when filler particles are used. This results in reduced thermomechanical stress.

The production process of a bushing as described in conjuntion with FIG. 1 typically comprises the steps of producing a creped paper 4 containing filler particles 14 (e.g., using processes known from the production of printing papers), winding the paper 4 (in one or more strips or pieces) onto the conductor 2, adding the equalization electrodes 5 during winding, applying a vacuum and applying the matrix material 6 to the vacuumized core 3 until the core 3 is fully impregnated. The impregnation under vacuum takes place at temperatures of typically between 50° C. and 90° C. Then the epoxy matrix material 6 is cured (hardened) at a temperature of typically between 100° C. and 140° C. and eventually post-cured in order to reach the desired thermomechanical properties. Then the core is cooled down, machined, and the flange 10, the insulating envelope 11 and other parts are applied.

The filler particles can be distributed approximately evenly in the spacer.

The use of a non-paper spacer material, e.g. a fibrous polymer grid or net, can allow the production of a paperless dry (oil-free) bushing. The process of drying a spacer paper before impregnation can be quickened or even skipped.

Typical voltage ratings for high voltage bushings are between about 10 kV to 1200 kV, at rated currents of 10 A to 100 kA.

FIG. 3 shows very schematically a HV- or MV apparatus 100 comprising, in this case, two bushings 1 as disclosed. The apparatus can, e.g., be a transformer 100 or also a switchgear 100. The apparatus 100 has a grounded housing, and inside there is high voltage HV. Other details of the apparatus 100 are not shown.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 bushing, condenser bushing
2 conductor
3 core
4 spacer, sheet-like spacer, paper
5 equalizing plate, aluminium foil
6 matrix material, epoxy
10 flange
11 insulating envelope (with sheds), hollow core composite
12 insulating medium, gel
14 filler particle
100 HV- or MV-apparatus, transformer, switchgear
A axis

What is claimed is:

1. Bushing with a conductor and a core surrounding the conductor, the core comprising equalization electrodes and a sheet-like spacer,
wherein the spacer contains filler particles which are pre-filled into the spacer before an impregnation process and which increase the thermal conductivity with respect to the spacer without any pre-filled particles.

2. Bushing according to claim 1, wherein by the spacer a multitude of layers surrounding the conductor is formed.

3. Bushing according to claim 1, wherein the filler-particle-containing spacer is impregnated with an electrically insulating matrix material.

4. Bushing according to claim 1, wherein the spacer comprises cellulose fibers.

5. Bushing according to claim 4, wherein the spacer comprises paper, in particular creped paper.

6. Bushing according to claim 1, wherein the spacer comprises a polymer.

7. Bushing according to claim 1, wherein the filler particles are electrically insulating or semiconductive particles.

8. Bushing according to claim 1, wherein the filler particles make up at least 1% by weight.

9. Bushing according to claim 1, wherein the spacer has a thermal conductivity of at least 0.3 W·m⁻¹·K⁻¹.

10. Bushing according to claim 1, wherein the spacer is wound around an axis, which axis is defined through the shape of the conductor, and that in appropriate radial distances to the axis equalization plates of metallic or semiconducting material are provided within the core.

11. High- or medium-voltage apparatus, comprising a bushing according to claim 1.

12. High- or medium-voltage apparatus, according to claim 11, wherein the high- or medium-voltage apparatus is a transformer.

13. Method of production of a bushing, wherein a sheet-like spacer is wound around a conductor or around a mandrel,
comprising the step of adding equalization electrodes during winding, characterized by the steps of:
Prefilling the sheet-like spacer with filler particles before an impregnation process, wherein the filler particles increase the thermal conductivity with respect to the spacer without any pre-filled particles.

14. Method according to claim 13, wherein the filler particles are incorporated into the spacer before the spacer is wound around the conductor or around the mandrel.

15. Method according to claim 14, comprising the steps of: applying matrix material to the vacuumized core until the core is fully impregnated under vacuum and curing the epoxy matrix material.

16. Bushing according to claim 5, wherein the spacer comprises a polymer.

17. Bushing according to claim 6, wherein the filler particles are electrically insulating or semiconductive particles.

18. Bushing according to claim 7, wherein the filler particles make up at least 5% by weight, of the spacer.

19. Bushing according to claim 8, wherein the spacer has a thermal conductivity of at least 0.8 W·m^{-1 ·K}⁻¹.

20. Bushing according to claim 9, wherein the spacer is wound around an axis, which axis is defined through the shape of the conductor, and that in appropriate radial distances to the axis equalization plates of metallic or semiconducting material are provided within the core.

21. High- or medium-voltage switchgear, comprising a bushing according to claim 10.

22. Method of production of a bushing, comprising:
winding a sheet-like spacer around a conductor or around a mandrel; and adding equalization electrodes during winding, wherein the sheet-like spacer is prefilled with filler particles before an impregnation process, and wherein the filler particles increase the thermal conductivity.
